(19) United States
(12) Patent Application Publication
(10) Pub. No.: US 2013/0144692 A1
(43) Pub. Date: Jun. 6, 2013

(54) Producing and Displaying Media Content on Heterogeneous Mobile Devices

(71) Applicants: Sami Mohammed Shalabi, Winchester, MA (US); Maurice Bennett Shore, Carlisle, MA (US); Cassandra Lynn Doll, Santa Clara, CA (US)

(72) Inventors: Sami Mohammed Shalabi, Winchester, MA (US); Maurice Bennett Shore, Carlisle, MA (US); Cassandra Lynn Doll, Santa Clara, CA (US)

(73) Assignee: Google Inc., Mountain View, CA (US)

(21) Appl. No.: 13/310,340

(22) Filed: Dec. 2, 2011

(51) Int. Cl. G06Q 30/02; G06Q 30/06; G06F 17/00

(52) U.S. Cl. 705/14.4; 715/249

(57) ABSTRACT

A system, computer-implemented method and computer-readable medium for displaying edition content are provided. An edition player is configured to receive a magazine edition, the magazine edition including a layout template for rendering edition content. The edition player is further configured to receive edition content subscribed to by the magazine edition, the edition content provided by a content source. The edition player then integrates the edition content within the magazine edition using the layout template to lay out the edition content based on a specification of the mobile device. The edition player then renders the edition content within the magazine edition.

### BACKGROUND

Users gain access to media content via the Internet or the World Wide Web (or simply the “Web”) using websites. In one example, users enter a website address on their mobile devices to access media content. In another example, users may download an application provided by a particular content provider onto their mobile device. The application then presents a user with a media content that is periodically uploaded to the application from a content source provided by the content provider. However, the design, presentation and publication of a media content application can be time consuming and arduous.

Moreover, because computing devices have unique specifications that include different operating platforms, a content provider needs to tailor each application to fit the processing requirements of a particular mobile device. As a result, a content provider needs to develop and maintain multiple applications that perform the same function, so that their content can reach as many users as possible.

### BRIEF SUMMARY

A system, computer-implemented method and computer-readable medium for displaying edition content are provided. An edition player is configured to receive a magazine edition, the magazine edition including a layout template for rendering edition content. The edition player is further configured to receive edition content subscribed to by the magazine edition, the edition content provided by a content source. The edition player then integrates the edition content within the magazine edition using the layout template to lay out the edition content based on a specification of the mobile device. The edition player then renders the edition content within the magazine edition.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1A is a block diagram of a distributed system environment, according to an embodiment.

FIG. 1B is a block diagram of components in distributed system 100 that generate and distribute magazine editions, according to an embodiment.

FIG. 1C is a block diagram that describes an exemplary communication interfaces between the components within the distributed system, according to an embodiment.

FIG. 2A is a block diagram of an edition player, according to an embodiment.

FIG. 2B is a block diagram of a current module for displaying magazine editions, according to an embodiment.

FIG. 3 is a block diagram of an applications data model, according to an embodiment.

FIG. 4A is a block diagram of a studio architecture, according to an embodiment.

FIG. 4B is a screen shot of an exemplary embodiment of a studio displaying a user interface.

FIG. 5 is a flowchart of a method for displaying edition content on a magazine edition, according to an embodiment.

FIG. 6 is a flowchart of a method for distributing a magazine edition on a producer server, according to an embodiment.

FIG. 7 is a flowchart of a method for generating a magazine edition, according to an embodiment.

FIG. 8 is a block diagram of a computer system in which embodiments of the invention can be implemented.

The invention will now be described with reference to the accompanying drawings. In the drawings, generally, like reference numbers indicate identical or functionally similar elements. Additionally; generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

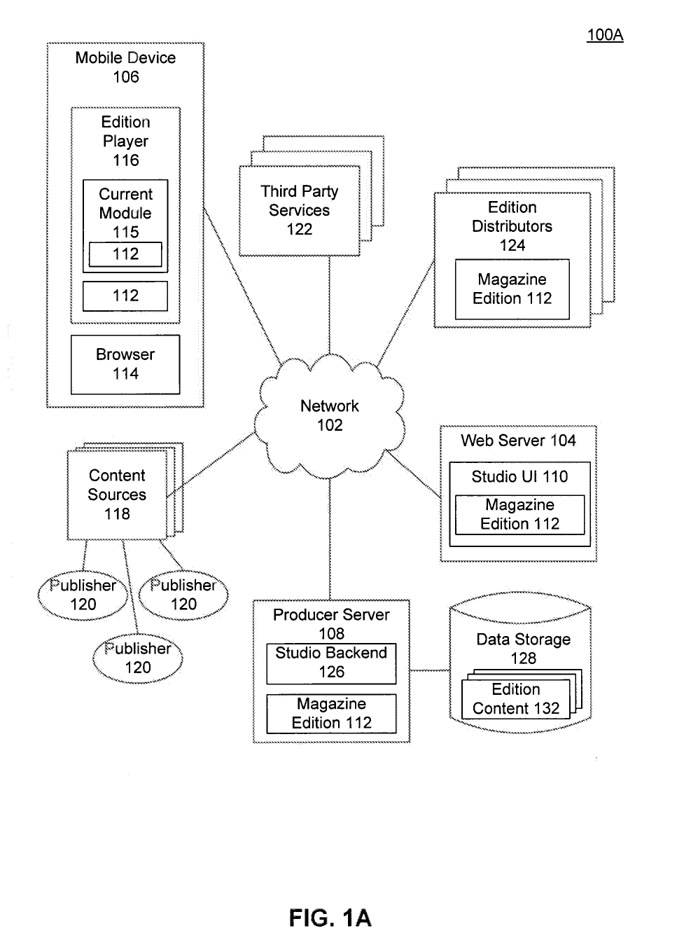

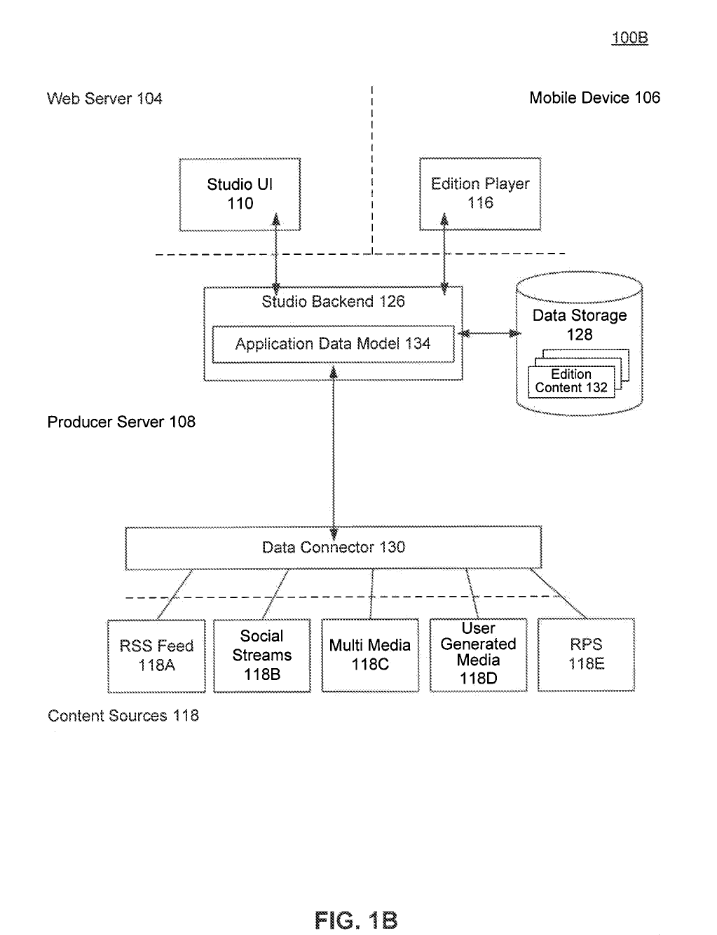

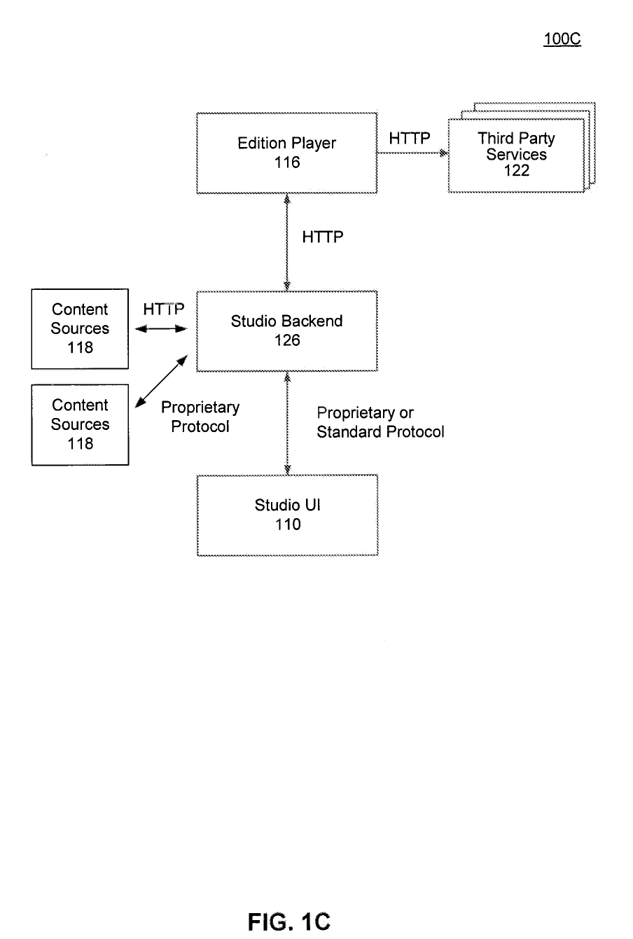

FIG. 1A is a block diagram 100A of a distributed system environment. Distributed system environment 100A includes one or more networks 102, web servers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106. Publisher 120 may access studio UI 110 using a web address that is hosted on web server 104. Once accessed, publisher 120 may use studio UI 110 to design the layout of magazine edition 112 and configure content sources 118 for mobile devices 106 having different specifications.

In another embodiment, publisher 120 may download studio UI 110 onto a mobile device 106 as a standalone application or as a plugin or extension to a browser.

Magazine edition 112 may be designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also layout edition content according to the size of a display screen of mobile device 106.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. In an embodiment, current module 115 also provides a user with a listing of recommended magazine editions 112 that may be of interest to the user and that a user may subscribe to.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112.

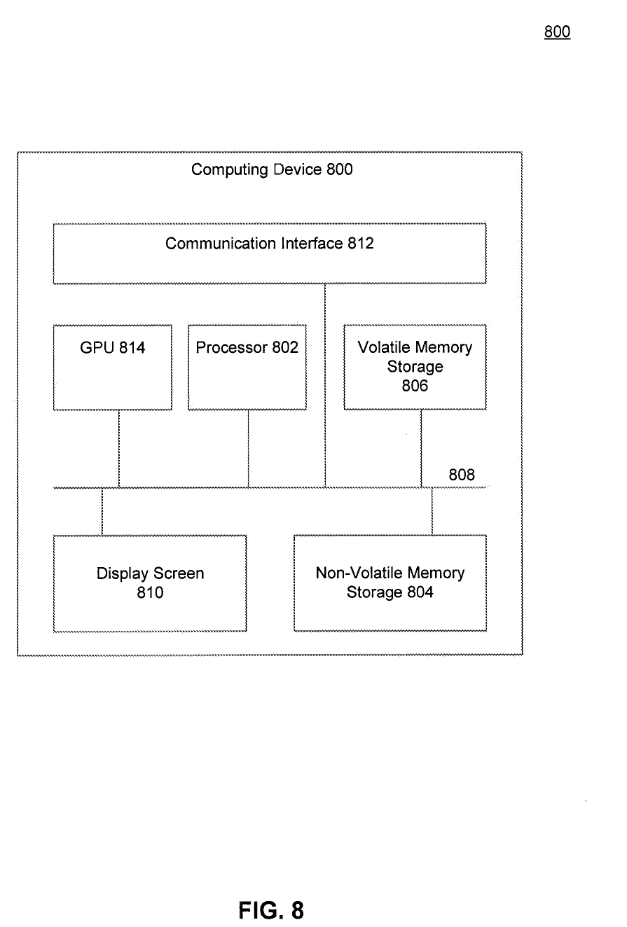

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 8. In another embodiment, publisher 120 may upload magazine edition 112 to edition distributors 124. A user may access edition distributor 124 and download magazine edition 112 to mobile device 106. In an embodiment, once publisher 120 decides to distribute an upgraded magazine edition 112, mobile devices 106 that include a previous version of magazine edition 112 are synchronized with the upgraded magazine edition 112.

Content sources 118 provide edition content 132 to magazine edition 112. Example content sources 118 include data feeds, RSS feeds, social streams, user-generated media sources, multi-media sources via media RSS, etc. Content source 118 is typically associated with a publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 8. In an embodiment, data storage 128 may include a database for storing edition content 132. When magazine edition 112 executing on edition player 116 requests edition content 132, producer server 108 retrieves edition content 132 is retrieved from data storage 128 and transmits edition content 132 to edition player 116.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112 to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. A user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein content sources 118 provide edition content 132 that is distributed across the web via network 102. For the edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 transmits edition content 132 to data storage 128.

As described herein, data storage 128 distributes data from content sources 118 to magazine editions 112. For example, mobile device 106 may request data for particular magazine editions 112 at configurable time intervals that may be configured by the user subscribing to magazine editions 112.

Studio backend 126 receives the designed magazine editions 112 from studio UI 110. As described herein, studio UI 110 allows publishers 120 to design dynamic and interactive magazine editions that display edition content 132 provided by their content sources 118. Once publisher 120 completes designing magazine edition 112, publisher 120 uploads magazine edition 112 to studio backend 126. Studio backend 126 then stores the uploaded magazine editions 112 on producer server 108 and/or distributes magazine editions 112 to mobile devices 106 or edition distributors 124.

Studio backend 126 includes application data model. Application data model (described in detail below) includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 120 for presentation to a user.

Upon a user request from mobile device 106, studio backend 126 may distribute magazine editions 112 to mobile devices 106. Each magazine edition 112 includes application data model 134 that is configured by publisher 120.

When magazine edition 112 is uploaded to mobile device 106, magazine edition 112 is populated with edition content 132. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102.

FIG. 1C is a block diagram 100C that describes an exemplary communication interface between the components within the distributed system.

For example, edition player 116 may communicate with studio backend 126 using HTTP over network 102. Edition player 116 may also communicate to third party services 122 and edition distributors 124 using HTTP.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skilled in that art, to pass data that includes magazine editions 112, templates, edition content 132, etc., between studio UI 110 and studio backend 126.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP.

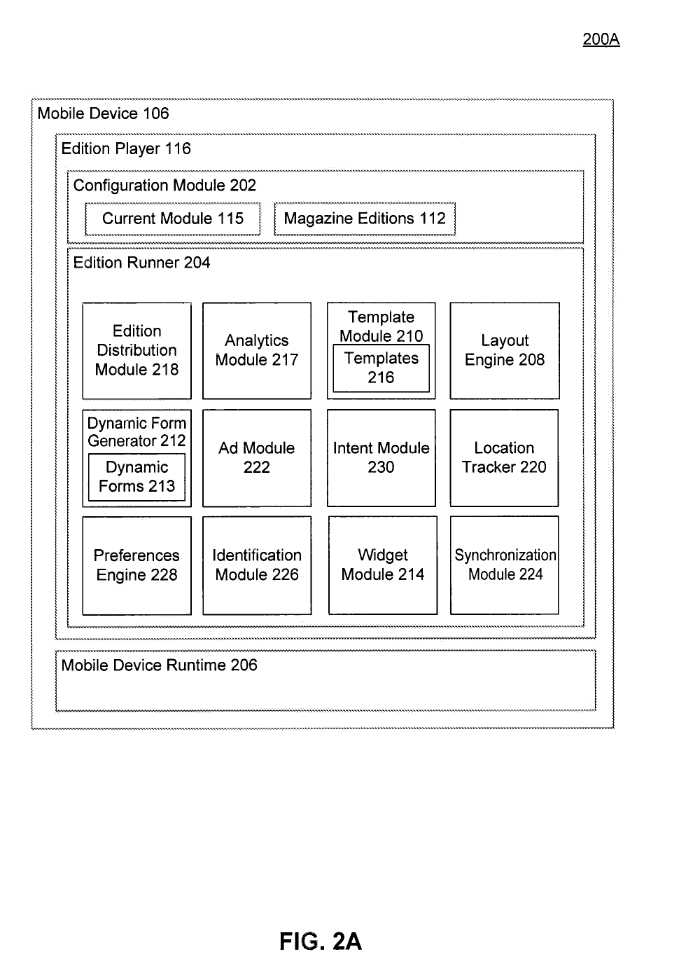

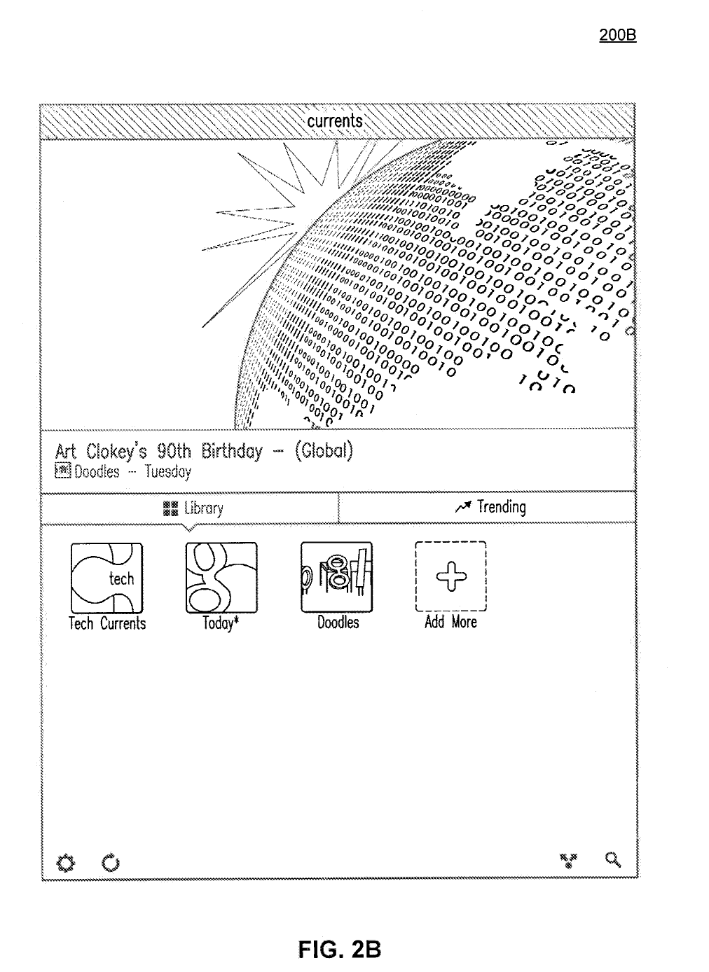

FIG. 2A is a block diagram 200 of an edition player. As described herein, edition player 116 displays magazine editions 112 to a user.

Edition player 116 includes a configuration module 202. Configuration module 202 determines a configuration mode that displays magazine edition 112 on edition player 116. For example, configuration module 202 may be configured to display magazine editions 112 using current module 115, in one embodiment. In another embodiment, configuration module 202 may be configured to display a single instance of magazine editions 112.

Edition runner 204 executes a configuration included in configuration module 202 and displays magazine editions 112. Example configuration may be executing a single instance of magazine edition 112 or executing current module 115 that provides a user with a selection of multiple magazine editions 112.

Edition runner 204 includes a layout engine 208. Layout engine 208 formats media content for display on mobile devices 106 having different specifications. Layout engine 208 receives edition content 132, using, for example, an HTML stream and generates a multi-column layout of edition content 132 that is appropriate for the display screen size and orientation of mobile device 106. Layout engine 208 interacts with template module 210, dynamic form generator 212 and widget module 214.

Template module 210 includes templates 216. Templates 216 control the rendering of the media content in magazine edition 112. Templates 216 may be native templates that are optimized for executing on edition runner 202, as they use the core mobile device runtime 206 libraries. Templates 216 may also be publisher 120 designed templates that display media content in a format designed by publisher 120. When magazine edition 112 is uploaded to mobile device 106, it stores templates 216 in template module 210.

Analytics module 217 tracks magazine editions 112, sections and articles within each magazine edition 112 viewed or read by a user. Analytics module 217 may compile a listing of the read content. The listing may be sent to publisher's 120 analytic account for determining edition content 132 that is interesting to users. The listing may also be sent to the user's account so that edition player 112 may provide a user with a history of edition content 132 that a user has read and/or accessed. Analytics module 217 may also track sections and articles within magazine editions 112 when a user browses magazine editions 112 offline (for example, without access to network 102). Once mobile device 106 is able to access network 102, analytics module 217 uploads the listing to publisher's 120 analytic account and/or user's account.

Edition distribution module 218 communicates with other applications, and distributes magazine editions 112 to third parties. Example third parties may include popular social networking sites, microblogging services, email accounts associated with users, etc., to name a few. Edition distribution module 218 may be accessed within magazine edition 112 when a user is reading a particular article or section and causes edition player 116 to distribute the read content.

Location tracker 220 identifies a location, such as latitude and longitude location of mobile device 106. Once the location of mobile devices 106 is identified, edition content 132 included in magazine edition 112 may be tailored to a location of mobile device 106.

Advertisement module 222 inserts advertisements into edition content 132 displayed by magazine edition 112. Advertisement module 222 determines where and when to include advertisements within magazine edition 112. For example, when layout engine 208 renders edition content 132 on a mobile device 106 in a way that includes an unfilled space, advertisement module 222 detects the unfilled space and queries an advertisement system to select an advertisement for inclusion in the unfilled space in real-time. Advertisement module 222 also communicates with various advertising entities that provide advertisement module 222 with advertisements for display within magazine edition 112.

Dynamic form generator 212 generates dynamic forms 213. Dynamic forms 213 render an arbitrary section within magazine edition 112 based on metadata provided by individual users. For example, dynamic forms 213 may be used to display submissions by individual users who, for example, practice citizen journalism.

Synchronization module 224 communicates with a studio backend 126 and retrieves edition content 132 from data storage 128. Synchronization module 224 also identifies the subscriptions that a user subscribed to using particular magazine editions 112 and synchronizes the edition content 132 included in the subscriptions with edition content 132 provided by content sources 118.

Widget module 214 enhances edition content 132 displayed in magazine edition 112. For example, when a slide show is included in edition content 132, widget module 214 renders the slide show. In another example, when edition content 132 includes geo-coordinates, widget module 214 launches an application that displays a map. In another example, when edition content 132 includes a video application, widget module 214 launches a video display application, etc. A person skilled in the art will appreciate that the embodiments above are given by way of example and not limitation and that other means for enhancing edition content 132 may be used.

Identification module 226 identifies a user that uses mobile device 106 and subscribes to particular magazine editions 112.

Preferences engine 228 determines the configuration of a user. For example, a user may configure time intervals for when magazine edition content is synchronized with studio backend 126.

Intent module 230 launches an application within edition runner 204 that a user wants to use to view edition content 132 in magazine edition 112. For example, when a user clicks on a post that includes a video, intent module 230 launches a video application. In another example, when a user wants to send an email, intent module 230 launches an email application.

Mobile device runtime 206 executes edition runner 204. Mobile device runtime 206 is a runtime that is native to mobile device 106. Mobile device runtime 206 allows a user to use edition player 116 to view magazine editions 112 on mobile device 106. Typically, mobile device 106 includes different mobile device runtimes 206 that execute mobile device 106 specific operating platforms.

FIG. 2B is an example display view of a current module for displaying multiple magazine editions, according to an embodiment.

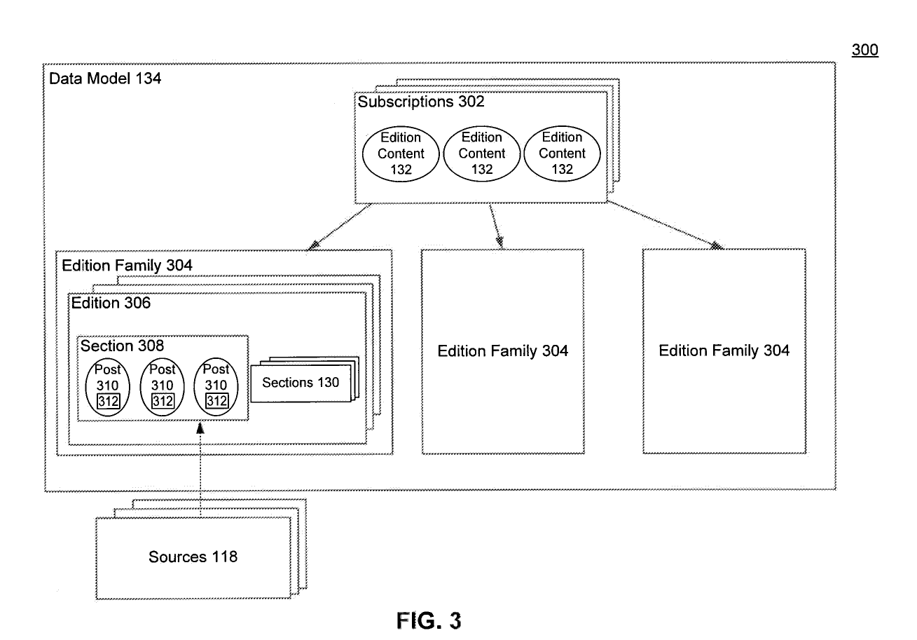

FIG. 3 is a block diagram 300 of a media application data model, according to an embodiment. Application data model 134 is a data model that magazine edition 112 uses to display edition content 132. When publisher 120 builds magazine edition 112 using studio UI 110, it configures edition content 132 into categories within application data model 134.

Application data model 134 includes multiple subscriptions 302. Each subscription 302 is a subscription to content source 118 from which a user subscribes to receive edition content 132 within magazine edition 112. A user may wish to subscribe to his own content source 118 when a user publishes content source 118 or may wish to subscribe to a third party's (e.g. publisher's 120) content source 118.

Magazine edition 112 includes multiple edition families 304 or a single edition 306. Each edition family 304 receives edition content 132 from a particular content source 118. Edition content 132 in each edition family 304 may be distributed among multiple editions 306. Example editions 306 for an edition family 304 may include news content, blog content, video content, etc. Typically, publisher 120 may decide which edition content from source 118 to include in a particular edition 306. Additionally, when publisher 120 designs each edition 306 using studio UI 110, multiple designers associated with a particular publisher 120 may design a particular edition 306 or a set of editions 306 at the same time.

Editions 306 may include multiple sections 308. Sections 308 organize edition content 132 that is provided from content sources 118. For example, edition 306 that includes news content may include a news section and a style section. In another example, edition 306 that includes travel content may include multiple travel sections where each section 308 corresponds to a different region in the world. Each section 308 also includes a table of contents, header, templates 216 for laying out edition content 132 on various mobile devices 106, content source identifiers, etc.

Each section 308 may also include a section type. Section type allows studio UI 110 to optimize the presentation of edition content 132 that is included in section 308 of a particular type. For example, section types may include an RSS feed type, video channel type, social stream type, photo type, products-for-sale type, user-generated articles type that includes citizen journalism, etc.

Each section 308 may have a custom design. In an embodiment, the custom design may be rendered from templates 216 that layout the content of each section 308. As described herein, templates 216 may be native templates provided by studio backend 126 or may be custom templates that are designed for a particular edition 306 or section 308 by publisher 120. In another embodiment, templates 216 may be used to render section 308 on a mobile device 106 that include display screens of different sizes, such as, for example, a tablet and a mobile phone.

Each section 308 includes posts 310. Post 310 represents data associated with a particular unit of content, such as an article, a video, a single image, a “tweet”, a slide show, a map, or any unit of content within content source 118. In an embodiment, post 310 includes multiple items 312. Each item 312 includes information associated with post 310. Example items 312 may include information such as a title, a body, an author, a byline, a media, etc. Depending of what items 312 are included in post 310, post 310 may display a video, an article, a shopping cart item, etc.

Because of the flexibility of application data model 134, a synchronization process of the new edition content 132 received from content sources 118 may be performed on a granularity level of each post 310, and without updating content included in entire edition 306 or section 308.

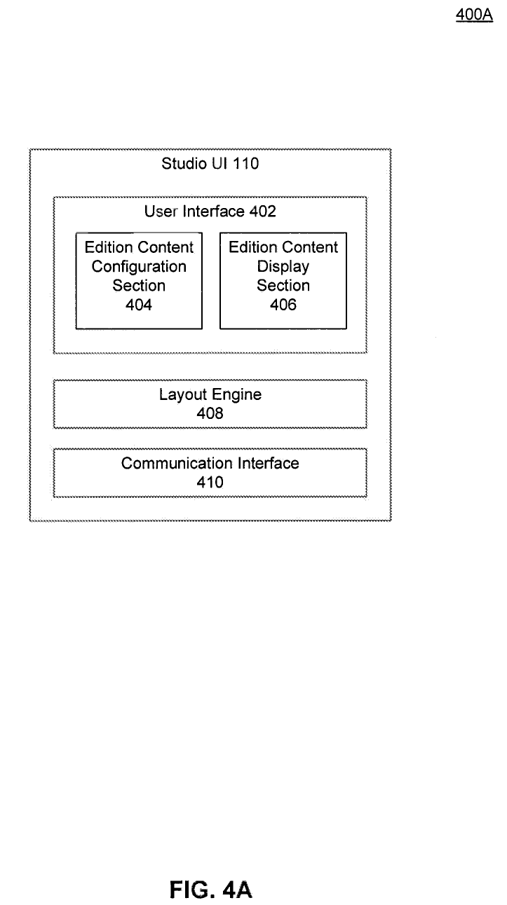

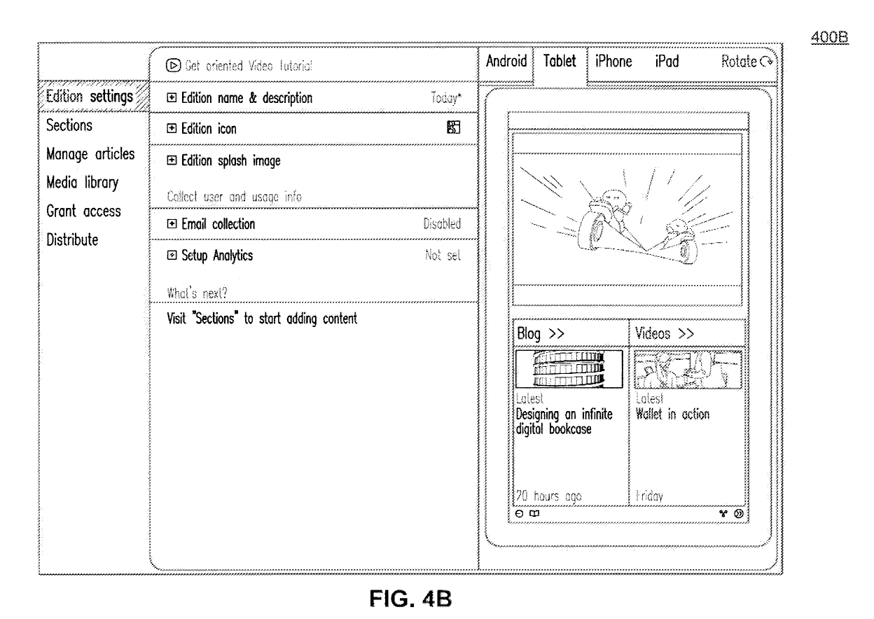

FIG. 4A is a block diagram 400A of a studio architecture, according to an embodiment. Studio UI 110 includes a user interface 402. User interface 402 allows publisher 120 to configure the layout of edition content 132 that is included in magazine edition 112. User interface 402 includes an edition content configuration section 404 and an edition content display section 406. Edition content configuration section 404 allows publisher 120 to select content source 118 that provides edition content 132 for display using magazine edition 112. Edition content configuration section 404 further allows publisher 120 to select multiple sections 308 to display edition content 132. As described herein, example sections 308 may include a news section, a video section, etc. Within each section 308, publisher 120 may further configure content source 118 that provides edition content 132 and template 216 that determines the format in which edition content 132 is displayed on mobile device 106. Edition content configuration section 404 also allows publisher 120 to tailor the display of edition content 132 to a particular mobile device 106.

Edition content configuration section 404 also allows publisher 120 to configure the user population that views edition content 132 provided by magazine edition 112. For example, each section 308 within magazine edition 112 may be configured for viewing by any user, a select group of users, etc.

Edition content configuration section 404 also allows publisher 120 to select advertisers that may provide advertisements to magazine edition 112. For example, when magazine edition 112 displays edition content 132 on mobile device 106, magazine edition 112 may query an advertiser and retrieve advertisements that may be integrated with edition content 132 and be displayed to a user.

Edition content configuration section 404 allows publisher 120 to select merchandise items that may be includes for sale in magazine edition 112. Edition content configuration section 404 also allows publisher 120 to configure a check out interface so that users are able to purchase the merchandise items that are offered for sale.

Edition content configuration section 404 allows publisher 120 to distribute magazine edition 112 to mobile devices 106 or edition distributors 124.

Edition content display section 406 displays edition content 132 from content sources 118 that are included in each magazine edition 112. In an embodiment, edition content display section 406 displays edition content 132 as it may be displayed on various mobile devices 106, such as a tablet or a smart phone. For example, publisher 120 may select to simulate edition content 132 using a particular mobile device 106. Additionally, edition content display section 406 allows publisher 120 to preview the display of edition content 132 using a vertical or horizontal orientation on mobile device 106.

Studio UI 110 also includes a layout engine 408. Layout engine 408 allows publisher 120 to preview edition content 132 as it may be displayed on mobile devices 106 having a particular specification. For example, layout engine 408 determines the size of the display screen of the mobile device 106 that a user selects to preview edition content 132. Layout engine 408 then uses the size of the display screen to format the content in columns as it may be displayed on mobile device 106.

Studio UI 110 includes a communication interface 410. Communication interface 410 receives edition content 132 from data storage 128 for content source 118 that publisher 120 selects for display using magazine edition 112. Publisher 120 may use the received edition content 132 to design sections 308 that display edition content 132 or simulate a layout of edition content 132 on mobile devices 106. In an embodiment, mobile device 106 may also use communication interface 410 to distribute magazine edition 112 when they are ready for distribution.

FIG. 4B is a screen shot of an exemplary embodiment of a studio displaying a user interface.

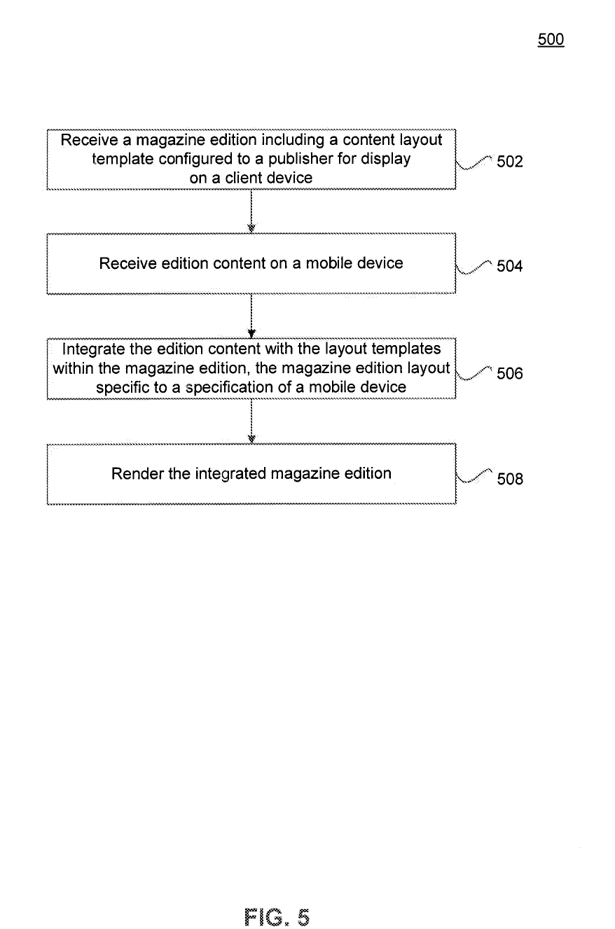

FIG. 5 is a flowchart of a method 500 for displaying edition content in a magazine edition, according to an embodiment. At stage 502, a magazine edition is received. For example, mobile device 106 receives magazine edition 112. As described herein, magazine edition 112 includes content layout templates that are configured by publisher 120. Magazine edition 112 may be stored within current module 115 as it is downloaded onto mobile device 106, in one embodiment. In another embodiment, a user may upload magazine edition 112 to execute using edition player 116.

At stage 504, edition content is received. For example, data storage 128 provides edition content 132 selected for display in magazine edition 112 from content source 118 configured by publisher 120. Example edition content 132 may include news articles, news summaries, media content such as images, video and thumbnails, merchandise lists, etc.

At stage 506, edition content is integrated within the magazine edition. For example, edition content 132 is integrated with the layout templates 216 included in magazine edition 112 that are configured by publisher 120. When edition content 132 is integrated on mobile device 106, edition content 132 is laid out to fit the display screen on mobile device 106 that has a particular operating platform. Moreover, advertisements may be included in magazine edition 112 as edition content 132 is integrated with the templates 216. For example, when layout engine 408 lays edition content 132 and includes an unfilled space either because an article or an image within edition content 132 does not fit the unfilled space within magazine edition, layout engine 408 may include an advertisement in the unfilled space.

At stage 508, the integrated magazine edition is rendered. For example, magazine edition 112 that includes edition content 132 in a format particular to mobile device 106 is rendered on a display screen of mobile device 106. Furthermore, integrated magazine edition 112 may be rerendered to display data in a horizontal and vertical orientation on mobile device 106.

The integration of the edition layout design and the edition and media content at mobile device 106 provides for a more flexible presentation of magazine editions on heterogeneous mobile devices. Such flexibility and resource efficiency is not available if magazines were painstakingly designed for each device and if all of the content was integrated and prepackaged prior to transmission to mobile device 106.

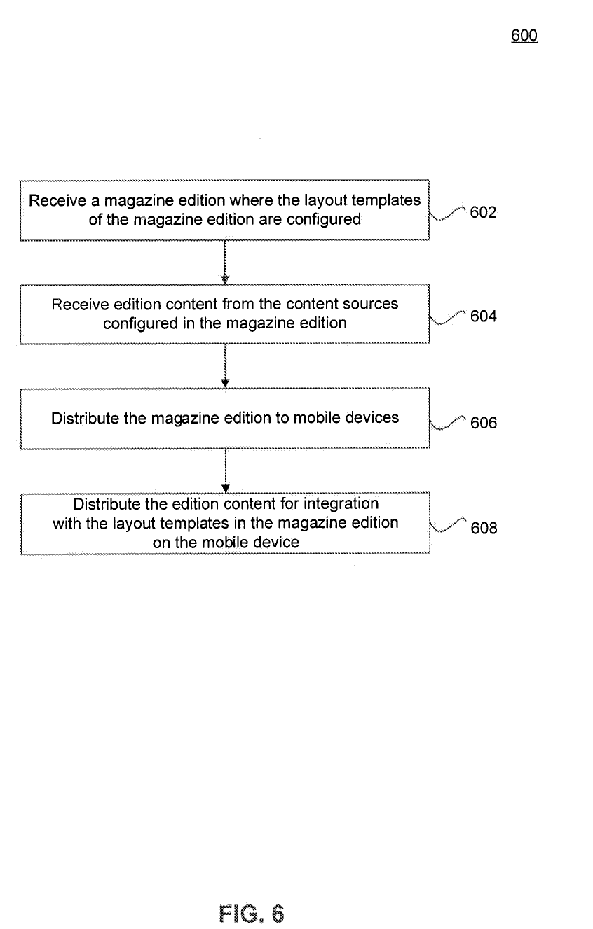

FIG. 6 is a flowchart of a method 600 for distributing a magazine edition on a producer server, according to an embodiment.

At stage 602, a magazine edition is provided. For example, once publisher 120 completes designing magazine edition 112 using studio UI 110, studio UI 110 uploads magazine edition 112 to producer server 108. Producer server 108 may store magazine edition 112 in its memory storage, so that magazine edition 112 may be distributed to mobile devices 106.

At stage 604, edition content is received. For example, when producer server 108 receives magazine edition 112 that is configured to receive edition content 132 from content sources 118, producer server 108 uses data connector 130 to connect to the configured content sources 118. Once connected, data connector 130 receives edition content 132 from content sources 118. The received edition content 132 may be stored in data storage 128.

At stage 606, a magazine edition is distributed. In one embodiment, producer server 108 distributes magazine editions 112 to mobile devices 106. In another embodiment, producer server 108 distributes magazine editions 112 to edition distributors 124.

At stage 608, edition content is distributed. For example, edition content 132 may be uploaded to magazine editions 112 that are uploaded to mobile devices 106. Once uploaded, edition content 132 and media content are rendered using magazine edition 112. In an embodiment, edition content 132 that is included in data storage 128 may be synchronized with the edition content that is included in magazine edition 112 on mobile device. As described herein, the synchronization may occur at configurable time intervals that may be configured by a user viewing magazine edition 112.

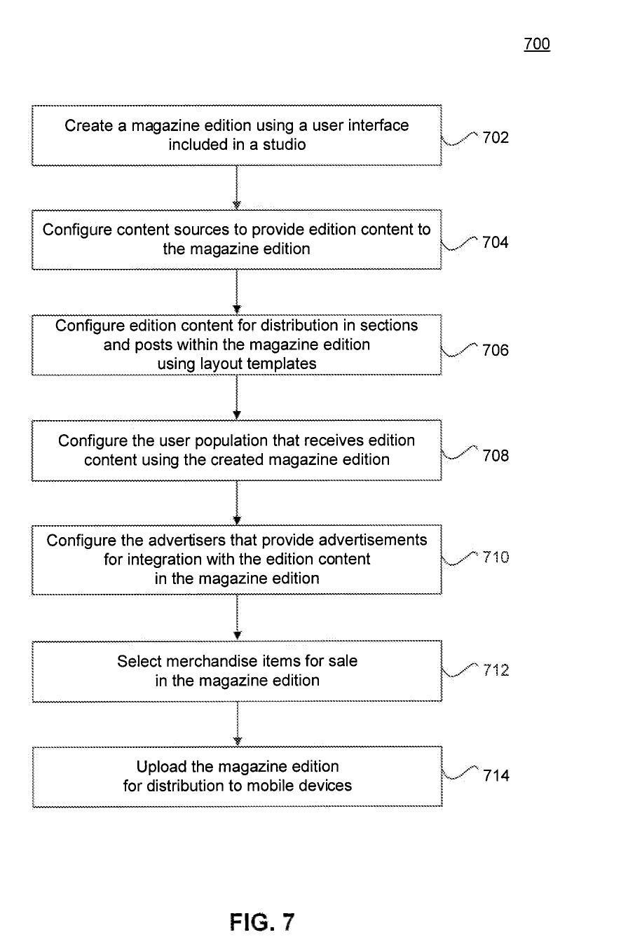

FIG. 7 is a flowchart of a method 700 for generating a magazine edition, according to an embodiment. At stage 702, a magazine edition is created. For example, studio UI 110 allows publisher 120 to create magazine edition 112 using user interface 402.

At stage 704, content sources are configured. For example, edition content configuration section 404 allows publisher 120 to configure edition content 132 from multiple content sources 118 for display in magazine edition 112. When studio UI 110 receives an indication that publisher 120 selected particular edition content 132, studio UI 110 allows publisher 120 to access edition content 132 that will be displayed using magazine edition 112.

At stage 706, edition content is configured for distribution between sections and posts. As described herein, each section 306 may correspond to a type of content source 118 such that studio UI 110 provides publisher 120 with templates display edition content 132 included in content source 118. In an embodiment, publisher 120 may also create custom templates that display edition content 132. Publisher 120 may also configure magazine edition 112 to include particular edition content 132 as post 310 and manipulate the headings and the titles on each post 310.

At stage 708, a user population is configured. For example, a user population that may view edition content 132 provided by magazine edition 112 is configured using edition content configuration section 404. Example user population may include exemplary categories such as, any user, a group of users, etc.

At stage 710, advertisers are configured. For example, studio UI 110 allows publisher 120 to select advertisers that may include advertisements in magazine edition 112 as it is being displayed on mobile device 106.

At stage 712, merchandise items are selected. For example, studio UI 110 allows publisher 120 to select items that may be included for sale in magazine edition 112 as it is displayed on mobile device 106. When a user selects a sale item, magazine edition 112 may route a user to a third party service for payment and check out services.

At stage 714, magazine edition is distributed. Studio UI 110 distributes magazine edition 112 to mobile devices 106. To distribute magazine edition 112 to mobile devices 106, studio UI 110 distributes magazine edition 112 to producer server 108. Producer server 108 stores magazine edition 112 and recommends magazine edition 112 to users who may be interested in edition content 132 included in magazine edition. The user may then cause a mobile device to upload magazine edition 112 to mobile device 106. In another embodiment, studio UI 110 may distribute magazine edition 112 to edition distributors 124. A user may then upload magazine edition 112 onto mobile device 106 from edition distributors 124. In an embodiment, when publisher 120 modifies an existing magazine edition 112, producer server 108 may download the modified magazine edition 112 to mobile devices 106 using network 102.

FIG. 8 is an example computer system 800 in which embodiments of the present invention, or portions thereof, may be implemented as computer-readable code. For example, the components or modules of distributed system 100, such as studio UI 110, magazine editions 112, current module 115, studio backend 126, etc., may be implemented in one or more computer systems 800 using hardware, software, firmware, tangible computer-readable media having instructions stored thereon, or a combination thereof and may be implemented in one or more computer systems or other processing systems. Modules and components in FIGS. 1-7 may be embodied in hardware, software, or any combination thereof.

Mobile device 106, web server 104 and producer server 108 may include one or more computing devices that include a computer system 800. Computer system 800 may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), and application specific integrated circuit (ASIC).

GPU 814 is a specialized processor that executes instructions and programs, selected for complex graphics and mathematical operations, in parallel.

Non-volatile storage 804 may include one or more of a hard disk drive, flash memory, and like devices that may store computer program instructions and data on computer-readable media. One or more of non-volatile storage device 804 may be a removable storage device.

Memory devices 806 may include one or more volatile memory devices such as but not limited to, random access memory. Communication infrastructure 808 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A computer-implemented method for displaying edition content having multiple types in a magazine edition on a mobile device comprising:
storing the magazine edition on the mobile device, wherein the magazine edition includes a plurality of layout templates for integration with edition content to display in the magazine edition;
receiving, at configurable time intervals, on the mobile device the edition content subscribed to by the magazine edition separately from the magazine edition and the plurality of layout templates, wherein the edition content having multiple types is provided by a plurality of content sources;
determining a specification of the mobile device, wherein the specification includes at least a size of a display screen and a type of an operating platform;
integrating, on the mobile device, the edition content subscribed to by the magazine edition with the plurality of layout templates based on the identified specification of the mobile device, wherein the integrating further comprises:
detecting an unfilled space when integrating the edition content with a layout template, wherein the unfilled space is caused by an article or an image included in the edition content that does not fit auto the unfilled space; and
querying an advertisement system identified in the magazine edition for an advertisement;
integrating the advertisement into the identified unfilled space within the magazine edition; and
displaying the edition content within the magazine edition on the mobile device.

2. The computer-implemented method of claim 1, further comprising:
identifying space for at least one section and at least one post in the magazine edition; and
integrating the received edition content into the at least one section and the at least one post.

3. (canceled)

4. (canceled)

5. The computer-implemented method of claim 1, further comprising:
integrating social media within the magazine edition.

6. The computer-implemented method of claim 1,
wherein the size and placement of the advertisement is based on the size of the display screen and a layout of the integrated edition content in the layout template.

7. The computer-implemented method of claim 1, further comprising:
integrating a merchandise selection within the magazine edition; and
providing access to a payment processing system for purchasing merchandise from the merchandise selection in the displayed magazine edition.

8. The computer-implemented method of claim 1, further comprising:
synchronizing new edition content with the edition content integrated in the magazine edition at configurable time intervals.

9. The computer-implemented method of claim 1, wherein the subscribed edition content includes a really simple syndication (RSS) and media content.

10. A system for displaying edition content having multiple types in a magazine edition on a mobile device comprising:
a processor;
a memory coupled to the processor;
an edition player stored in the memory and executing on the processor of the mobile device and configured to:
store the magazine edition on the mobile device, wherein the magazine edition includes a plurality of layout templates for integration with edition content to display in the magazine edition;
receive edition content subscribed to by the magazine edition separately from the magazine edition and the plurality of layout templates from, wherein the edition content having multiple types is provided by a plurality of content sources;
determine a specification of the mobile device, wherein the specification includes at least a size of a display screen and a type of an operating platform;
integrate on the mobile device, the edition content subscribed to by the magazine edition with the plurality of layout templates based on the identified specification of the mobile device, wherein to integrate the edition content, the edition player is further configured to:
detect an unfilled when integrating the edition content with a layout template, wherein the unfilled space is caused by an article or an image included in the edition content that does not fit into the unfilled space;
query an advertisement system identified in the magazine edition for an advertisement; and
integrate the advertisement into the identified unfilled space within the magazine edition; and
display the edition content within the magazine edition on the mobile device.

11. The system of claim 10, further comprising a layout engine configured to:
identify space for at least one section and at least one post in the magazine edition; and
integrate the received edition content into the at least one section and the at least one post.

12. (canceled)

13. (canceled)

14. The system of claim 10, wherein the edition player is further configured to integrate social media within the magazine edition.

15. The system of claim 10,
wherein the size and placement of the advertisement is based on a size of the display screen and a layout of the integrated edition content in the layout template.

16. The system of claim 10, wherein the edition player is further configured to:
integrate a merchandise selection within the magazine edition; and
provide access to a payment processing system for purchasing a merchandise from the merchandise selection in the magazine edition.

17. The system of claim 10, wherein the edition player is further configured to:
synchronize new edition content with the edition content integrated in magazine edition at configurable time intervals.

18. The system of claim 10, wherein the subscribed edition content includes a really simple syndication (RSS) and media content.

19. A computer-implemented method for distributing a magazine edition, comprising:
receiving the magazine edition for displaying edition content on a mobile device for storage on a server, wherein the magazine edition includes a plurality of layout templates for integration with edition content having multiple types in the magazine edition;
receiving the edition content having multiple types from a plurality of content sources configured within the magazine edition;
distributing the magazine edition and the plurality of templates to the mobile device; and
distributing at configurable time intervals, the edition content to the magazine edition to the mobile device, wherein the edition content is distributed separately from the magazine edition and the plurality of layout templates, and
wherein the edition content is integrated on the mobile device with the plurality of layout templates included in the magazine edition and the integration is based on at least a size of a display screen and a type of an operating platform, and wherein during integration of the edition content with a layout template, an unfilled space article or an image included in the edition content that does not fit into the unfilled space is detected, a query to an advertisement system identified in the magazine edition for an advertisement is made and the advertisement is integrated into the identified unfilled space within the magazine edition.

20. A system for distributing a magazine edition, comprising:
a producer server configured to:
receive the magazine edition configured to display edition content on a mobile device for storage on the producer server, wherein the magazine edition includes a plurality of layout templates configured to integrate edition content to display the magazine edition;
receive edition content of different types from a plurality of content sources configured within the magazine edition;
distribute the magazine edition and the plurality of templates to the mobile device; and
distribute, at configurable time intervals, the edition content to the magazine edition distributed to the mobile device, the edition content distributed separately from the magazine edition and the plurality of layout templates, wherein the edition content is integrated on the mobile device with the plurality of layout templates included in the magazine edition and the integration is based on a display screen and a type of an operating platform, and wherein during integration of the edition content with a layout template, an unfilled space caused by an article or an image included in the edition content that does not fit into the unfilled space is detected, a query to an advertisement system identified in the magazine edition for an advertisement is made and the advertisement is integrated into the identified unfilled space within the magazine edition.
